(19) United States
(12) Patent Application Publication
(10) Pub. No.: US 2007/0186210 A1
(43) Pub. Date: Aug. 9, 2007

(54) Instruction set encoding in a dual-mode computer processing environment

(75) Inventors: Zahid Hussain, Ascot (GB); Yang (Jeff) Jiao, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/347,922

(22) Filed: Feb. 6, 2006

(51) Int. Cl. G06F 9/44

(52) U.S. Cl. 717/106

(57) ABSTRACT

Provided is an instruction set for a dual-mode computer processing environment that includes instructions divided into multiple instruction groups. The instructions include mode-specific fields, common fields, and group-specific fields. Also a method for encoding an instruction set in a dual-mode computer processing environment is provided. The method includes dividing the instruction set into a instruction groups and defining common fields, group-specific fields, mode-specific fields, and mode-configurable fields.

### TECHNICAL FIELD

The present disclosure is generally related to computer processing and, more particularly, is related to a method and instruction set in a dual-mode computer processing environment.

### BACKGROUND

As is known, to improve the efficiency of multi-dimensional computations, Single-Instruction, Multiple Data (SIMD) architectures have been developed. A typical SIMD architecture enables one instruction to operate on several operands simultaneously. In particular, SIMD architectures take advantage of packing many data elements within one register or memory location. With parallel hardware execution, multiple operations can be performed with one instruction, resulting in significant performance improvement and simplification of hardware through reduction in program size and control. Traditional SIMED architectures perform mainly “vertical” operations, in which the corresponding elements in separate operands are operated upon in parallel and independently. Another way of describing vertical operations is in terms of memory utilization. In a vertical mode operation for each processing element there is a local memory storage such that the address within each local memory storage for the operands is common.

Although many applications currently in use can take advantage of such vertical operations, there are a number of important applications, which require the rearrangement of the data-elements before vertical operations can be implemented so as to provide realization of the application. Exemplary applications include many of those frequently used in graphics and signal processing. In contrast with those applications that benefit from vertical operations, many applications are more efficient when performed using horizontal mode operations. Horizontal mode operations can also be described in terms of memory utilization. The horizontal mode operation resembles traditional vector processing where a vector is setup by loading the data into a vector register and then processed in parallel. Processors in the state of the art can also utilize short vector processing, which implements a vector operation such as a dot product as multiple parallel operations followed by a global sum operation.

In many operations, the performance of a graphics pipeline is enhanced by utilizing vertical processing techniques, where portions of the graphics data are processed in independent parallel channels. Other operations, however, benefit from horizontal processing techniques, in which blocks of graphics data are processed in a serial manner. The use of both vertical mode and horizontal mode processing, also referred to as dual mode, presents challenges in providing a single instruction set encoded to support both processing modes. The challenges are amplified by the utilization of mode-specific techniques including, for example, data swizzling, which generally entails the conversion of names, array indices, or references within a data structure into address pointers when the data structure is brought into main memory. For at least these reasons, encoding an instruction set for a dual-mode computing environment and methods of encoding the instruction set will result in improved efficiencies.

Thus, a heretofore-unaddressed need exists in the industry to address the aforementioned deficiencies and inadequacies.

### SUMMARY

Embodiments of the present disclosure provide an instruction set for a dual-mode computer processing environment, comprising: a plurality of instructions divided into a plurality of instruction groups; a plurality of mode-specific fields in each of the plurality of instructions; a plurality of common fields in each of the plurality of instructions; and a plurality of group-specific fields in each of the plurality of instructions.

Embodiments of the present disclosure can also be viewed as providing methods for encoding an instruction set in a dual-mode computer processing environment, comprising: dividing the instruction set into a plurality of instruction groups; defining a plurality of common fields, adapted to store data common to the plurality of instruction groups; defining a plurality of group-specific fields, adapted to store data specific to instructions in one or more of the plurality of instruction groups; defining a plurality of mode-specific fields, adapted to store mode specific data; and defining a plurality of mode-configurable fields, adapted to provide a first configuration in a first computing mode and a second configuration in a second computing mode.

Embodiments of the present disclosure can also be viewed as providing methods for providing an instruction set in computer processing environment utilizing vertical and horizontal processing modes, comprising: means for grouping a plurality of instructions in the instruction set into a plurality of instruction groups; means for defining a plurality of common instruction fields common to each of the plurality of instructions; means for defining a plurality of group-specific instruction fields specific to each of the plurality of instruction groups; means for defining a plurality of mode-specific instruction fields configured to store a first content in the vertical processing mode and a second content in the horizontal processing mode; and means for defining a plurality of mode-configurable instruction fields configured to provide a first data configuration in the vertical processing mode and a second data configuration in the horizontal processing mode.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a computer system as utilized in the disclosure herein.

FIG. 2 is a block diagram illustrating exemplary instruction groups in an embodiment as disclosed herein.

FIG. 3 is a block diagram illustrating exemplary three-source operand instructions in an embodiment as disclosed herein.

FIG. 4 is a block diagram illustrating exemplary two-source operand floating-point instructions in an embodiment as disclosed herein.

FIG. 5 is a block diagram illustrating exemplary one-source operand floating-point instructions in an embodiment as disclosed herein.

FIG. 6 is a block diagram illustrating exemplary one or two source operand integer instructions in an embodiment as disclosed herein.

FIG. 7 is a block diagram illustrating exemplary register immediate integer instructions in an embodiment as disclosed herein.

FIG. 8 is a block diagram illustrating exemplary branch instructions in an embodiment as disclosed herein.

FIG. 9 is a block diagram illustrating an exemplary long-immediate instruction in an embodiment as disclosed herein.

FIG. 10 is a block diagram illustrating exemplary zero-operand instructions in an embodiment as disclosed herein.

FIG. 11 is a block diagram illustrating exemplary fields common to all instructions in an embodiment as disclosed herein.

FIG. 12 is a block diagram illustrating exemplary fields specific to instruction groups in an embodiment as disclosed herein.

FIG. 13 is a block diagram illustrating exemplary fields specific to processing modes in an embodiment as disclosed herein.

FIG. 14 is a block diagram illustrating exemplary fields that are mode configurable in an embodiment as disclosed herein.

FIGS. 15A and 15B are block diagrams illustrating exemplary instruction formats corresponding to three-source operand instructions corresponding to vertical mode and horizontal mode processing, respectively, in an embodiment as disclosed herein.

FIGS. 16A and 16B are block diagrams illustrating exemplary instruction formats corresponding to two-source operand floating point instructions corresponding to vertical mode and horizontal mode processing, respectively, in an embodiment as disclosed herein.

FIGS. 17A and 17B are block diagrams illustrating exemplary instruction formats corresponding to one-source operand floating-point instructions corresponding to vertical mode and horizontal mode processing, respectively, in an embodiment as disclosed herein.

FIGS. 18A and 18B are block diagrams illustrating exemplary instruction formats corresponding to one or two source operand integer instructions corresponding to vertical mode and horizontal mode processing, respectively, in an embodiment as disclosed herein.

FIGS. 19A and 19B are block diagrams illustrating exemplary instruction formats corresponding to register-immediate integer instructions corresponding to vertical mode and horizontal mode processing, respectively, in an embodiment as disclosed herein.

FIGS. 20A and 20B are block diagrams illustrating exemplary instruction formats corresponding to branch instructions corresponding to vertical mode and horizontal mode processing, respectively, in an embodiment as disclosed herein.

FIGS. 21A and 21B are block diagrams illustrating exemplary instruction formats corresponding to long immediate instructions corresponding to vertical mode and horizontal mode processing, respectively, in an embodiment as disclosed herein.

FIGS. 22A and 22B are block diagrams illustrating exemplary instruction formats corresponding to zero operand instructions corresponding to vertical mode and horizontal mode processing, respectively, in an embodiment as disclosed herein.

FIG. 23 is a block diagram illustrating an exemplary embodiment of a method of encoding an instruction set in a dual-mode computer processing environment.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications, and equivalents included within the spirit and scope of the disclosure as defined by the appended claims.

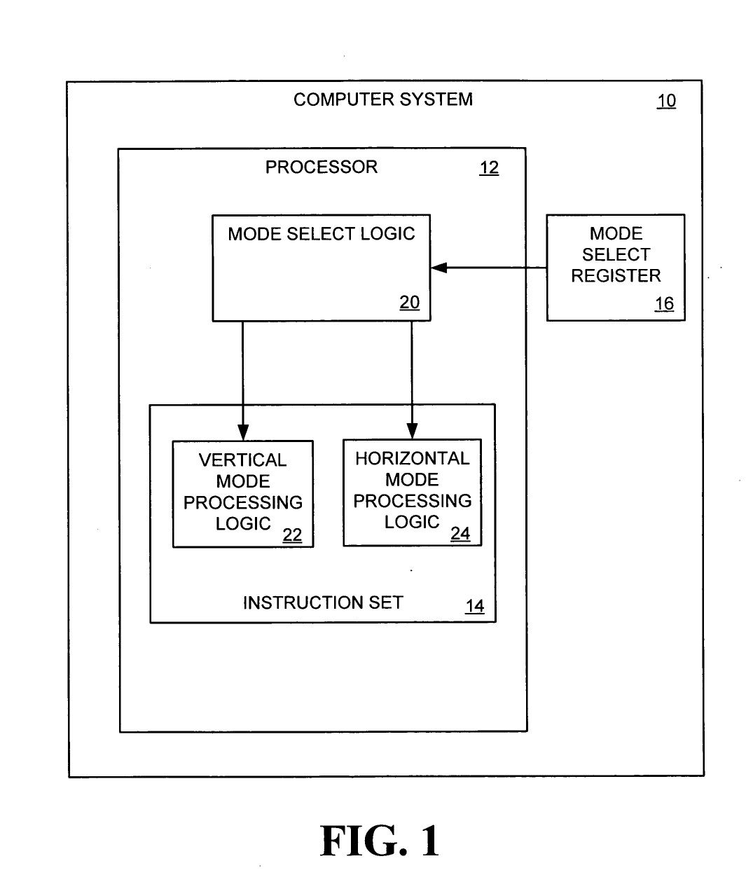

Reference is now made to FIG. 1, which is a block diagram of a computer system as utilized in the disclosure herein. In addition to other non-illustrated components, such as, for example, memory, a power supply, an output device, and an input device, the computer system 10 includes a processor 12 for performing data processing tasks within the computer system 10. The processor 12 includes mode-select read logic 20 that reads a mode-select register 16, also located in the computer system 10. The mode-select register 16 stores a value that determines whether or not the processor will operate in a vertical processing mode or a horizontal processing mode. The processor 12 also includes an instruction set 14, which is encoded to include instructions having vertical mode processing logic 22 and horizontal mode processing logic 24. Depending on the value stored on the mode-select register 16, the process will utilize either vertical mode processing logic 22, which includes the instructions in the instruction set 14 that are configured to perform processing in a vertical processing mode or the horizontal mode processing logic 24, which includes instructions in the instruction set 14 that are configured to perform in a horizontal processing mode.

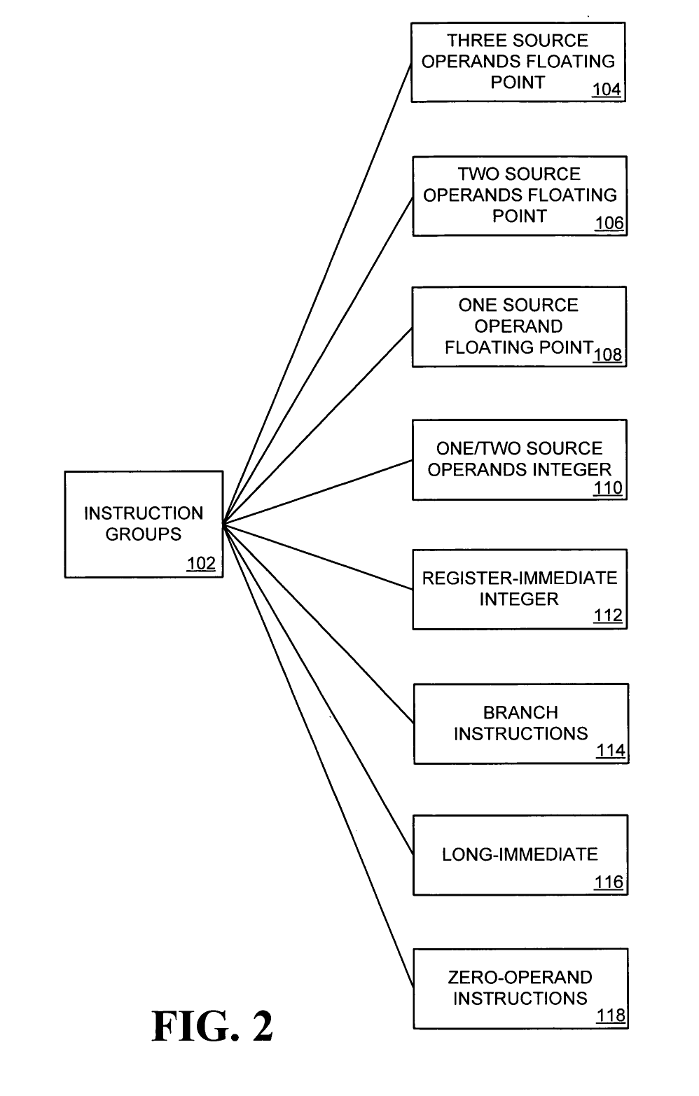

Reference is now made to FIG. 2, which is a block diagram illustrating exemplary instruction groups in an embodiment. Encoding an instruction set in an embodiment as disclosed herein includes dividing or grouping the instructions into multiple instruction groups 102. The instruction groups 102 of embodiments consistent with FIG. 2 are divided according to the operand configurations or requirements corresponding to different instructions. For example, instructions in a group corresponding to three source operands in a floating point operation 104, utilize arguments or operands in three different source registers. Accordingly, the group of instructions which utilize two source operands in a floating point operation 106 perform operations which utilize two arguments located in two different source registers. Similarly, all instructions utilizing a single source operand in a floating point operation 108 are grouped together.

In addition to the groups of floating point operations, another group is compiled of instructions utilizing one or two source operands in an integer operation 110. While not included in any embodiments herein, a three source operand integer operation is also contemplated within the scope and spirit of this disclosure. Yet another instruction group is formed by those instructions utilizing an operand located in a register in conjunction with an immediate value within the instruction in an integer operation 112. A group of branch instructions 114 includes those instructions which use an immediate label value to provide program control or alternative process thread routing. Program control can also be accomplished using instructions in the long immediate instruction group 116, which can be used, for example, in a jump instruction to provide a new value for the program counter. Other instructions used for program control include those in the zero-operand instruction group 118. These instructions, for example, can provide a constant value for loading into the program counter.

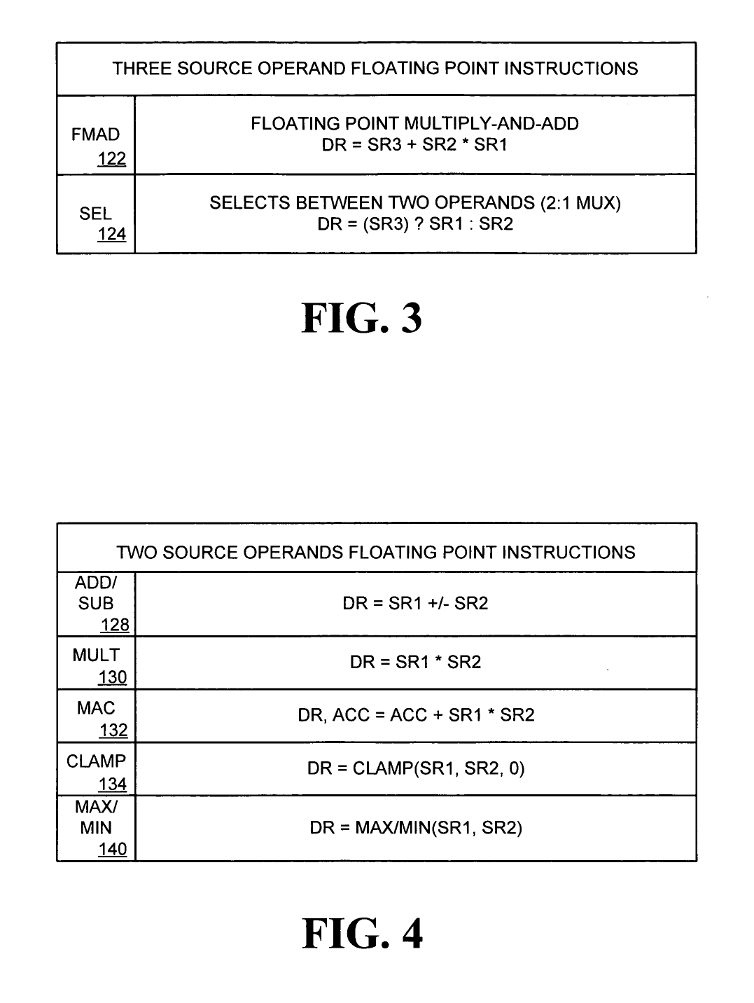

Reference is now made to FIG. 3, which is a block diagram illustrating exemplary three-source-operand instructions in an embodiment as disclosed herein. A non-limiting example of a three-source operand floating-point instruction includes a floating point multiply and add (FMAD) operation 122. The FMAD operation, multiplies the value located in source register one with the value located in source register two and adds that product to the value located in source register three. The source registers one, two, and three are the registers identified in the instruction fields designated as Source 1, Source 2, and Source 3, respectively. The resulting value is then written to the destination register. The destination register is the register identified in the instruction field designated destination. As an alternative to providing argument or operand values in the source registers, the values located in the source registers can be pointer values pointing to memory addresses containing the actual operand value. Another non-limiting example of a three-source operand floating-point instruction is a select function 124. The select function uses the value located in source register three to determine which of the values located in source register one or source register two are written to the destination register. In this manner, the select instruction operates much like a two-to-one multiplexer. One of ordinary skill in the art will appreciate that these instructions are presented as non-limiting examples of three-source-operand floating-point instructions and are not intended to limit the scope or spirit of the disclosure herein.

Reference is now made to FIG. 4, which is a block diagram illustrating exemplary two-source-operand floating point instructions in an embodiment as disclosed herein. Floating point instructions using two source operands include, for example, add/subtract 128, multiply 130, multiply/accumulate 132, clamp 134 and maximum/minimum instructions 140. Given the elemental nature of these instructions, explanation of the specific operation of each of the individual instructions will be limited to that presented in FIG. 4. The instructions presented in FIG. 4 are merely non-limiting examples of instructions that can be included in the two-source operand instruction group.

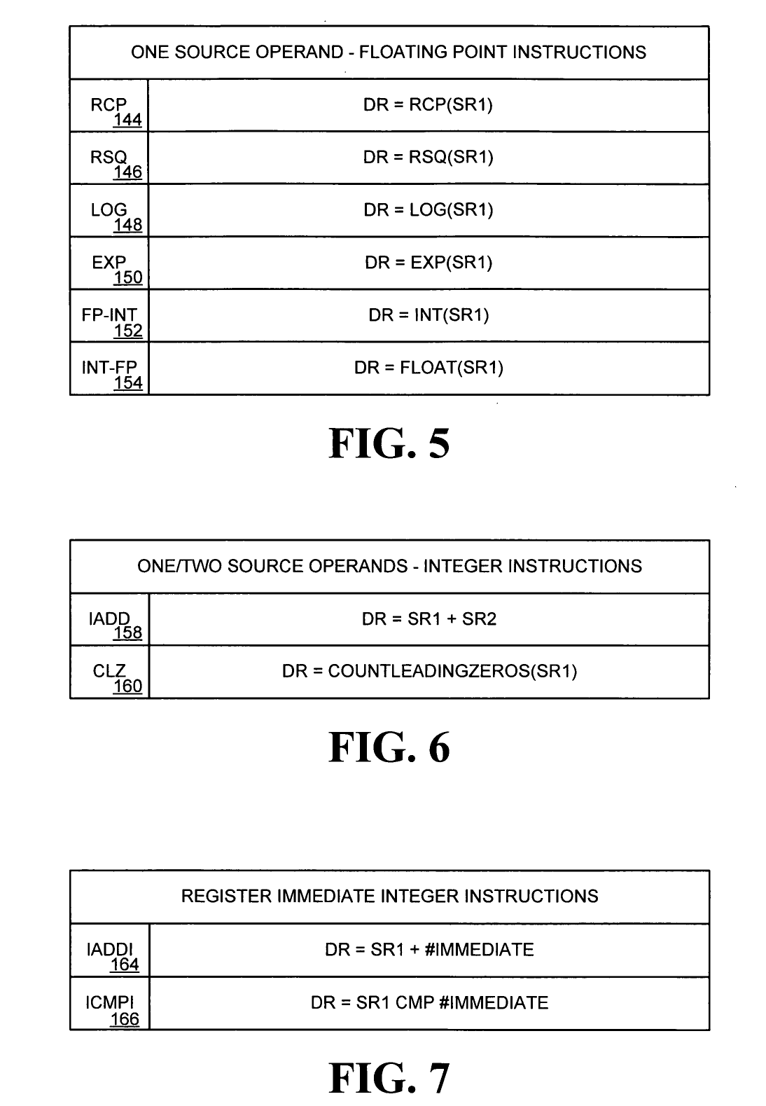

Similarly, reference is now made to FIG. 5, which is a block diagram illustrating exemplary one-source-operand floating-point instructions in an embodiment as disclosed herein. The one-source-operand floating-point instructions can include reciprocal (RCP) 144, square root (RSQ) 146, logarithm (LOG) 148, exponential (EXP) 150, floating-point to integer (FP-INT) 152, and integer to floating point (INT-FP) 154, among others. Each of these instructions, as well as, any other instructions, which might be appropriately grouped as a one-source operand floating-point instruction performs a function on a value in the source one register and stores the result in the destination register.

Reference is now made to FIG. 6, which is a block diagram illustrating exemplary one-or two-source-operand integer instructions. A non-limiting example of a two source integer instruction is the integer add instruction (IADD) 158, where the integer values stored in source registers one and two are added and the sum is written to the destination register. A non-limiting example of a one-source-operand integer instruction is the count leading zeros instruction (CLZ) 160, which counts the leading zeros of the value located in source register one and stores that value in the destination register. Similar integer instructions are presented in FIG. 7, which is a block diagram illustrating exemplary register-immediate integer instructions. For example, the integer add immediate instruction (IADDI) 164 adds the value in source register one with the value stored in the immediate field of the instruction and writes the sum to the destination register. Similarly, an integer compare immediate instruction (ICMPI) 166 compares the value in source register one with the value located in the immediate field of the instruction and writes the comparison result to the destination register.

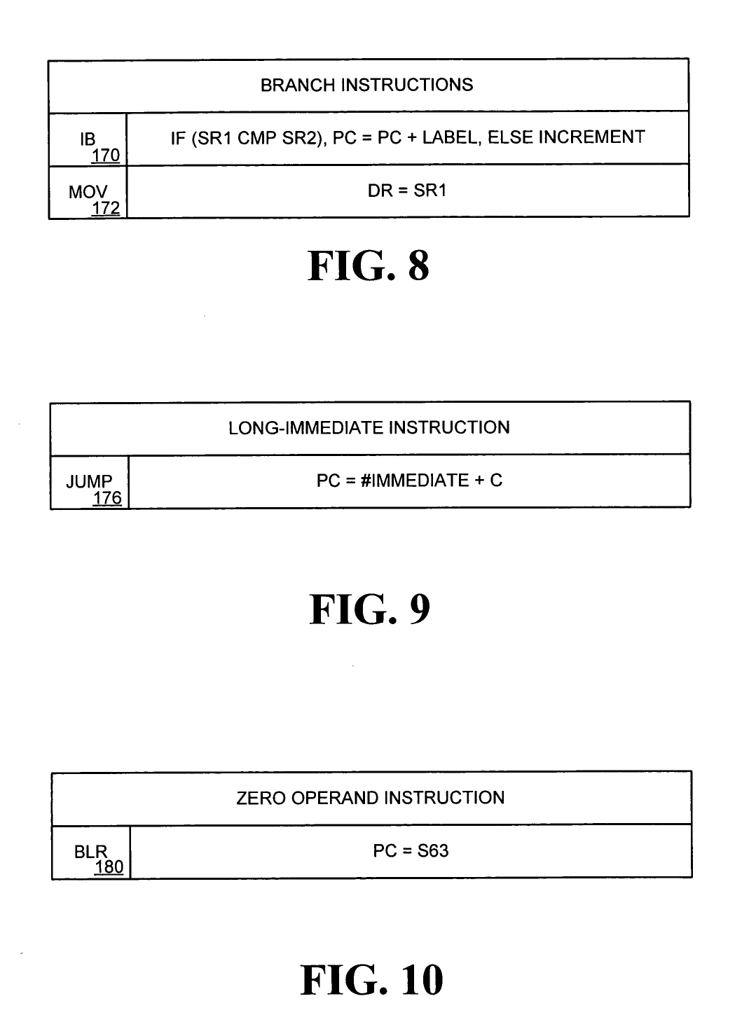

Reference is now made to FIG. 8, which is a block diagram illustrating exemplary branch instructions in an embodiment as disclosed herein. One non-limiting example of a branch instruction is an increment branch instruction (IB) 170, which compares the value in source register one with the value in source register two and, if the compare is true, adjusts the program counter by the value in the label field. If, in the alternative, the compare is false, the program counter is incremented. Another non-limiting example of a branch instruction is a move instruction (MOV) 172. The move instruction 172 moves the value in source register one to a destination register.

Reference is now made to FIG. 9, which is a block diagram illustrating an exemplary long-immediate instruction. An example of a long immediate instruction is the jump (JUMP) instruction 176, which adjusts the program counter by the value in the immediate field of the instruction plus an optional constant value. In some embodiments, the constant value may be stored in a portion of the long-immediate field.

Reference is now made to FIG. 10, which is a block diagram illustrating an exemplary zero operand instruction. A non-limiting example of a zero operand instruction is the branch label reset instruction (BLR) 180. The branch label reset instruction 180 is utilized to terminate the process branch by returning or resetting the program counter to a fixed value.

The above non-limiting examples of instructions in the instruction groups as illustrated in FIGS. 3-10 are not intended to limit the scope or spirit of this disclosure. To the contrary, many additional instructions consistent with this disclosure are contemplated and are likely necessary in a substantially complex computing environment. Further, the specific groupings as defined are merely exemplary and are not intended to limit the scope or spirit of this disclosure.

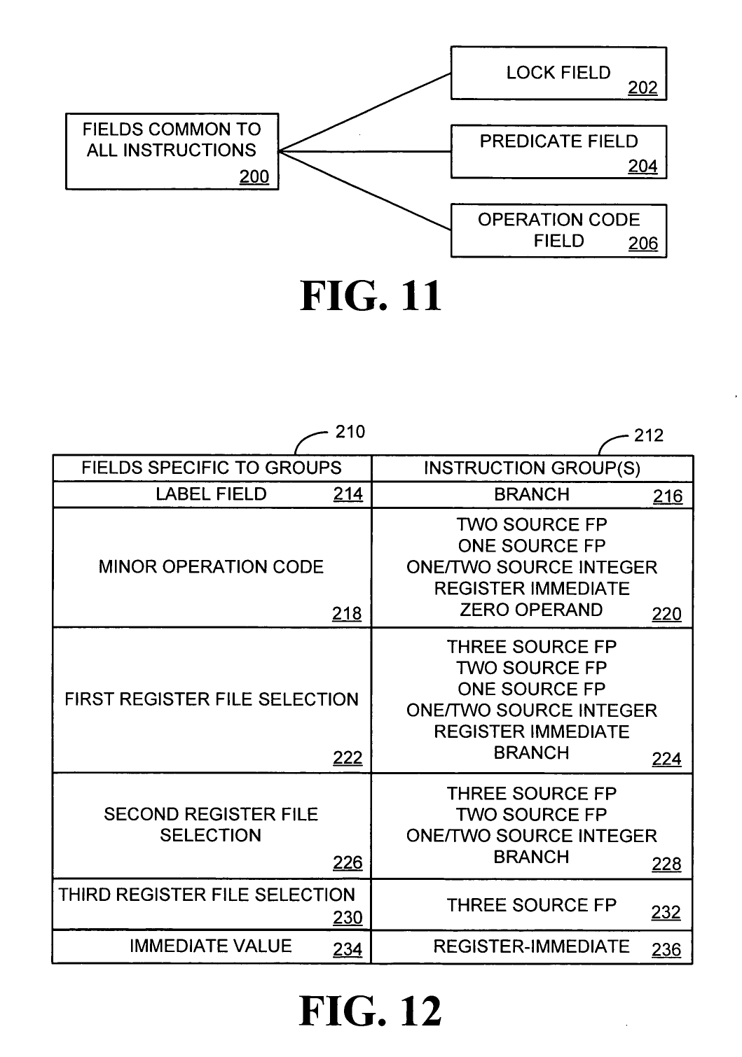

Reference is now made to FIG. 11, which is a block diagram illustrating exemplary fields common to all instructions. The fields common to all instructions 200 include fields that occur in all of the instructions regardless of instruction group or processing mode. For example, all instructions in some embodiments include a lock field 202, which is a bit utilized to indicate that a pipeline is locked. If the processing pipeline is locked, instructions from a given thread must flow through the execution unit that the operation was scheduled for when the pipe was locked and the thread must not be moved to another execution unit.

Additionally, the pipeline or process thread can be locked to a given execution unit because certain operations, including, for example, the multiply and accumulate (MAC) operation, utilize accumulation registers. The accumulation registers are implicitly used and not explicitly defined in the instruction and can incorporate other state information, such as, for example, historical information from a previous operation. Since this additional information is tied to and moves with a specific process thread, the process thread must be locked to a given execution unit in order to exploit the state information previously generated.

All instructions can also include a predicate field 204. The predicate field 204 can include a predicate negate bit configured to signal when the content of the predicate register is negated and the predicate register field to specify which of the predicate register is used n the predicate operation. Another field common to all instructions is the operation code field 206. The operation code field 206 is used to distinguish between the various instruction coding functions. The operation code field 206 can be configured to include an instruction type as well as a value representing specific instruction information. Additionally, the operation code field 206 can contain major operation code information that operates in conjunction with minor operation code information located in another field.

Reference is now made to FIG. 12, which is a block diagram illustrating exemplary fields specific to instruction groups. Examples of fields specific to instruction groups 210 are listed with exemplary instruction groups 212 that can include those fields. For example, in some embodiments a label field 214, which provides a label value that is aligned relative to the current program counter, can be included in all instructions in the branch instruction group 216. A minor operation code 218 can occur in all instructions in two-source floating-point, one-source floating-point, one/two-source integer, register-immediate, and zero-operand instruction groups 220. Similarly, a first register file selection field 222 can be utilized in the instructions in the three-source floating-point, two-source floating-point, one-source floating-point, one/two-source integer, register-immediate, and branch instruction groups 224. Additionally, a second register file selection field 226 can be utilized in instructions in the three-source floating-point, two-source floating-point, one/two-source integer, and branch instruction groups 228. A field for defining the third register file selection 230 occurs in instructions in the three-source floating-point instruction group 232. An immediate-value field 234 can be utilized in all instructions in the register-immediate instruction group 236. The above-discussed fields represent non-limiting examples of fields specific to groups according to the previously defined instruction groups. Other embodiments consistent with the scope and spirit of this disclosure can include instruction groups defined using different criteria and corresponding instruction fields specific to those alternatively defined groups.

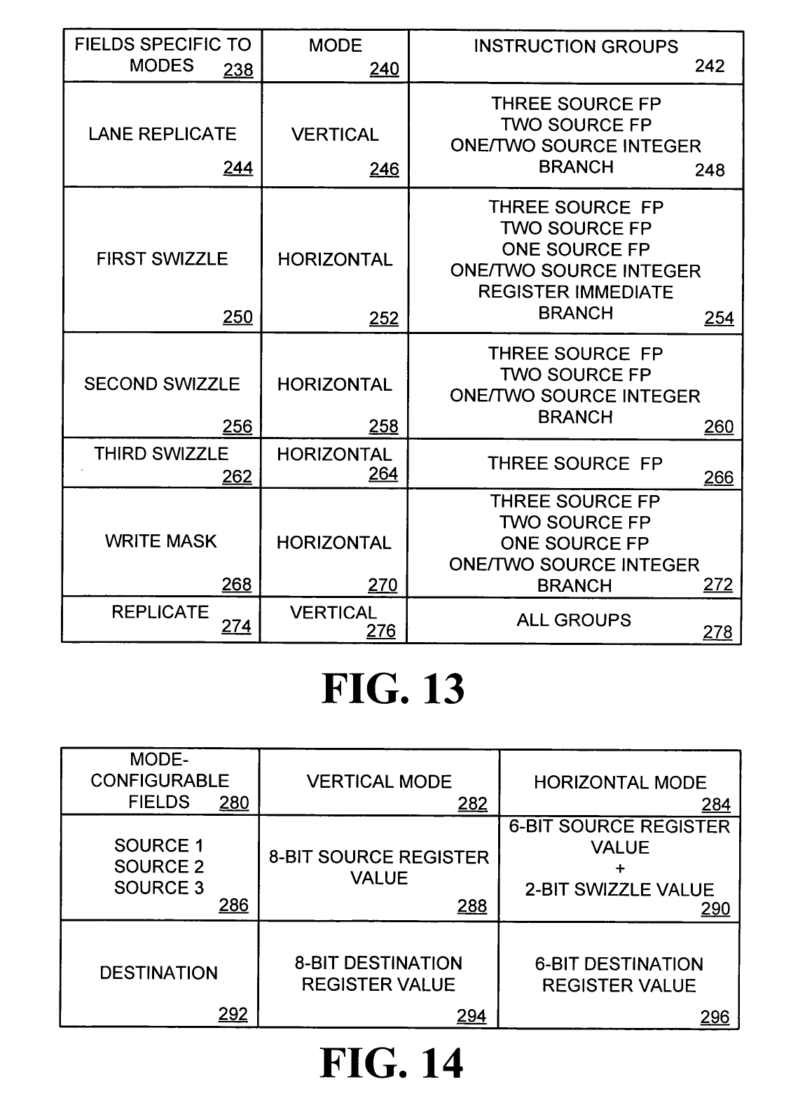

Reference is now made to FIG. 13, which is a block diagram illustrating exemplary fields specific to processing modes. For example, the fields identified in this figure are utilized in instructions corresponding to either the vertical or horizontal processing mode. A non-limiting example includes the lane replicate field 244, which is utilized only in vertical processing 246 and can occur, for example, in instructions in the three-source floating-point, two-source floating-point, one/two-source integer, and branch instruction groups 248. A first swizzle field 250 can be utilized in instructions encoded for horizontal mode processing 252 in, for example, the three-source floating-point, the two-source floating-point, a one source floating point, the one/two-source integer, a register-immediate, and the branch instruction groups 254. A second swizzle field 256 is utilized in instructions encoded for horizontal processing 258 and can apply to instructions, for example, in the three-source floating-point, two-source floating-point, one/two-source integer, and branch instruction groups 260. A third swizzle field 262 can be utilized in instructions configured to perform horizontal processing 264 in, for example, the three-source floating-point instruction group 266. A write mask field 268 is utilized in instructions configured to perform horizontal mode processing 270 in the three-source floating-point, the two-source floating-point, the one-source floating-point, the one/two-source integer, and the branch instruction groups 272. A replicate field 274 can be utilized in all instruction groups 278 configured for vertical mode processing 276.

Reference is now made to FIG. 14, which is a block diagram illustrating exemplary fields that are mode-configurable. The term mode-configurable applies where a general field is available in both vertical mode 282 and horizontal mode 284, and the field is configured differently for each of the two modes. For example, the source fields for source one, source two, and source three, listed in block 286 can each contain an 8-bit source register value in the vertical mode as shown in block 288 versus a 6-bit source register value plus a two-bit swizzle value in the horizontal mode as shown in block 290. Similarly, the destination field of block 292, can be configured as an 8-bit destination register value in the vertical mode as shown in block 294 and be configured as a 6-bit destination register value in the horizontal mode shown in block 296.

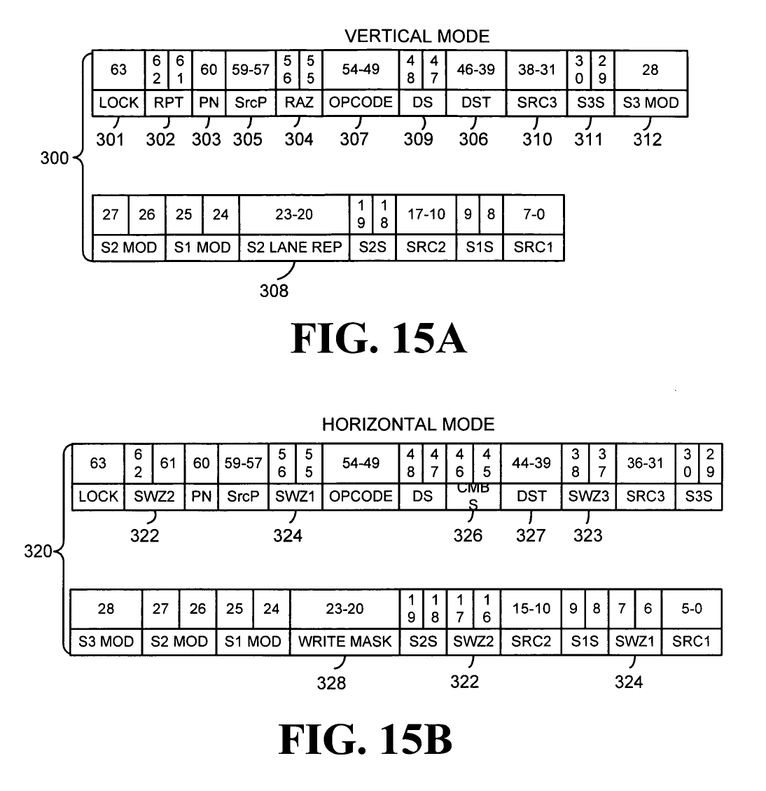

Reference is now made to FIGS. 15A and 15B, which are block diagrams illustrating exemplary instruction formats corresponding to three-source-operand instructions utilized in vertical-mode and horizontal-mode processing, respectively. Reference is first made to FIG. 15A, which is an embodiment of an instruction format for a three-source-operand floating-point instruction used in vertical mode processing. The instruction 300 can include a lock field 301, which as discussed above, is utilized to lock instructions in a given thread to a specific execution unit. The instruction 300 also can include a replicate field 302 containing a value that indicates how many times an instruction is modified and then replicated. Additionally, the instruction 300 can include predicate data, which includes a predicate negate bit 303 and a source predicate field 305, which identifies the predicate register. The instruction 300 can include a field identified as RAZ or read as zero 304, which is a label that identifies fields not used in a given format. The instruction 300 further includes an OPCODE or operational code field 307, as discussed above. The operational code field 307 defines the operation being performed by the instruction.

Data regarding the destination register can be stored in two different fields within the instruction. The first destination field is the destination register file field 309, which identifies the file in which the destination register resides. The second destination field is the destination register field 306, which identifies the specific destination register that receives the result of the operation or instruction. The instruction 300 also includes a source three field 310, which identifies the third source operand register location. Additionally, the instruction 300 can include the S3S field 311, which specifies the file selection for the third source operand. The instruction 300 can also include source modifier fields 312 used to indicate that one of the sources needs to be modified, through, for example, negation. The instruction 300 can also include a lane replication field 308 corresponding to the second source operand. Lane replication is specific to vertical mode and involves replicating the content of one lane to other lanes for the second source operand.

Reference is now made to FIG. 15B, which illustrates the instruction format for instructions in the three-source-operand floating-point instruction group when used in a horizontal processing mode. The horizontal mode instruction 320 includes several distinguishing features when compared to the same instruction group in the vertical mode. For example, each of the three-source-operands includes a swizzle value, which is used to specify a swizzle register in the horizontal mode. The swizzle value for the first source operand is a four-bit value that can specify any one of up to sixteen swizzle registers and is located at bits 56, 55, 7, and 6. The swizzle value for the second source operand is also a four-bit value and is similarly split among bits 62, 61, 17, and 16. In contrast with the swizzle values corresponding to the first and second source operands, the swizzle value corresponding to the third source operand 323 is a two-bit field that specifies one of up to four swizzle registers. Also in contrast with the vertical mode instructions, the horizontal mode instruction 320 includes a write mask 328 which is a four-bit value corresponding to W, Z, Y, and X components. An additional difference between the vertical mode instruction format 300 and the horizontal mode instruction format 320 is the difference in field length between all of the source operands. Where the vertical mode uses eight-bits for each source operand, the horizontal mode utilizes only six-bits for the source operand and reserves the other two bits for the swizzle value.

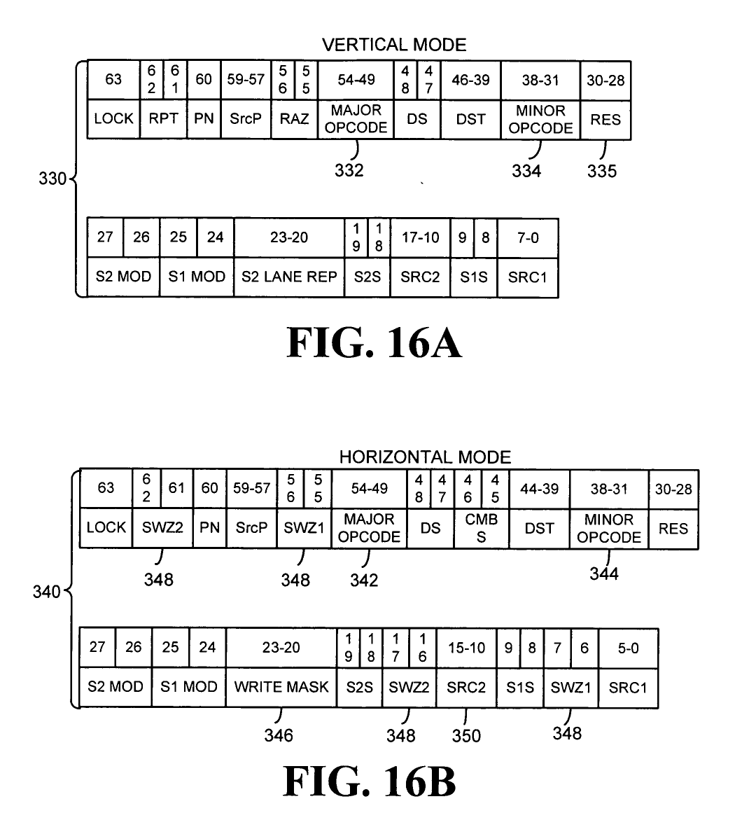

Reference is now made to FIGS. 16A and 16B, which are block diagrams illustrating exemplary instruction formats corresponding to two source operand floating-point instructions utilized in vertical-mode and horizontal mode processing, respectively. Referring first to FIG. 16A, the vertical mode instruction 330 includes a major OPCODE or operational code field 332 and a minor OPCODE or operational code field 334. The major OPCODE field 332 is utilized to distinguish between various instruction types. For example, the major OPCODE field 332 it signals that the remainder of the operation is encoded in the minor OPCODE field 334. The minor OPCODE field 334 can be utilized, for example, to encode mathematical or logical functions. The vertical-mode instruction format 330 also can include a reserved field 335 that can be used to accommodate future instructions or future processor functionality.

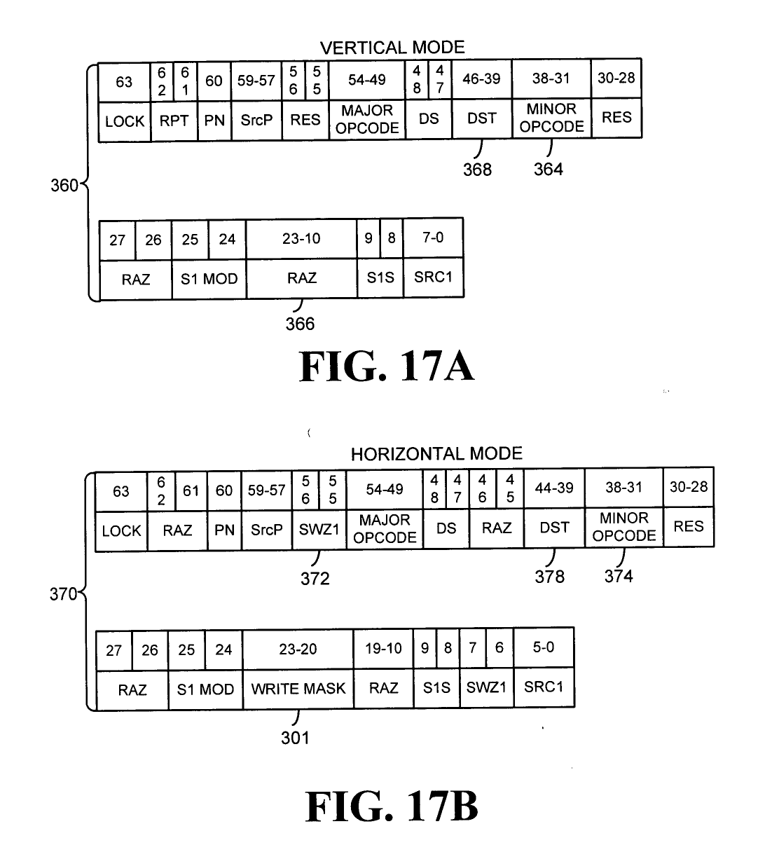

Referring to the horizontal mode instruction format 340 as shown in FIG. 16B, in contrast with the vertical-mode instruction, the horizontal-mode instruction format includes the swizzle value fields 348 and a write mask field 346. Note that other distinctions between the horizontal-mode instruction format 340 and the vertical-mode instruction format 330 in the two-source-operand floating-point instructions are consistent with those in the three-source-operand floating-point instructions. Similarly, in reference to FIGS. 17A and 17B, which are block diagrams illustrating exemplary instruction formats corresponding to one-source-operand floating-point instructions utilized in vertical-mode and horizontal-mode processing, respectively, the swizzle fields 372 and the write mask field 376 in the horizontal-mode instruction format 370 are not included in the vertical-mode instruction format 360.

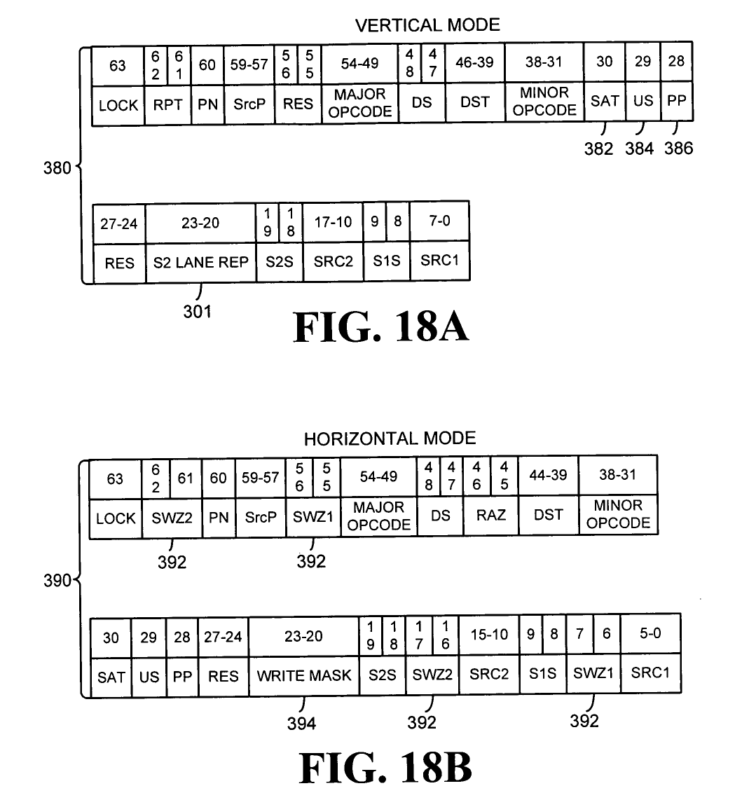

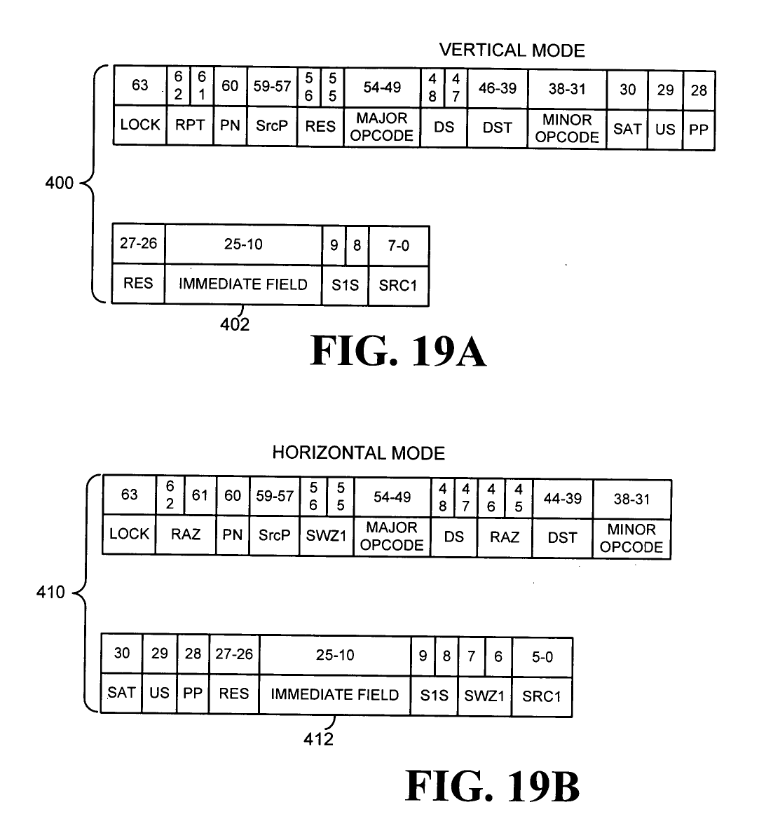

Reference is now made to FIGS. 18A and 18B, which are block diagrams illustrating exemplary instruction formats corresponding to one/two-source-operand integer instructions utilized in vertical-mode and horizontal-mode processing, respectively. While the instruction format for the integer operations includes many of the features utilized in the floating-point operations and includes the general distinctions between a vertical-mode processing instruction format and a horizontal-mode processing instruction format as previously discussed, the one/two-source-operand integer instruction formats for vertical-mode 380 and horizontal-mode 390 both include a SAT field 382, a US field 384 and a PP field 386. The SAT field 382 is a saturation field wherein if the bit is set then the result of the operation is saturated or in other words not modulo. The value in the SAT field 382 will depend, in part, on values in the US and PP fields 384, 386. The US field 384 determines whether the values in the source registers are treated as signed or unsigned values. The PP field 386 denotes whether the operation is treated as a partial precision operation. These fields are also found in the vertical-mode and horizontal-mode instruction formats corresponding to register immediate integer instructions, as illustrated in FIGS. 19A and 19B. Both the vertical-mode instruction format 400 and the horizontal-mode instruction format 410 corresponding to register-immediate integer instructions include an immediate value field 402, 412. The immediate value field contains a value that serves as an operand in an integer operation where another operand, if necessary, is located in a first source operand register.

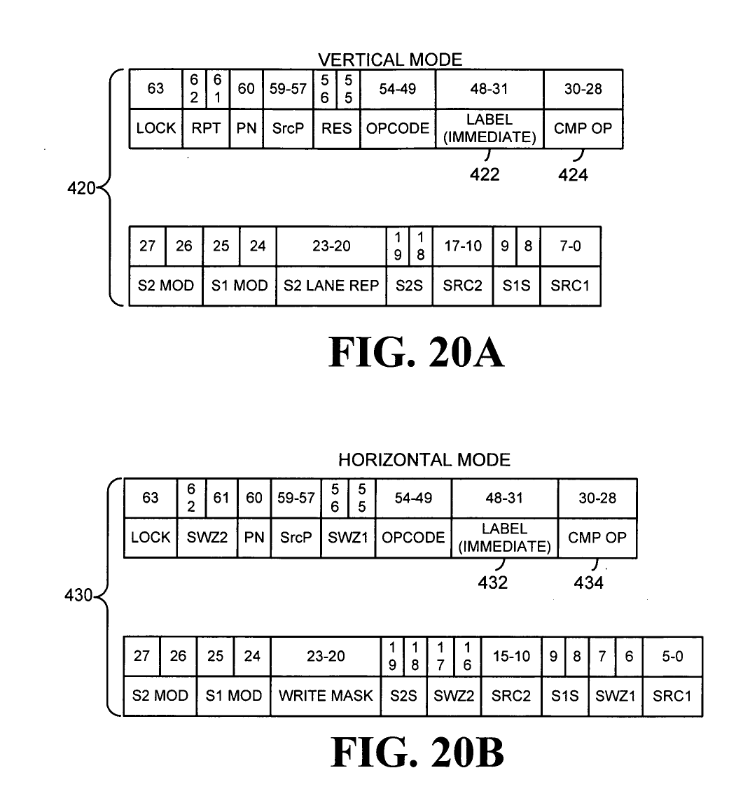

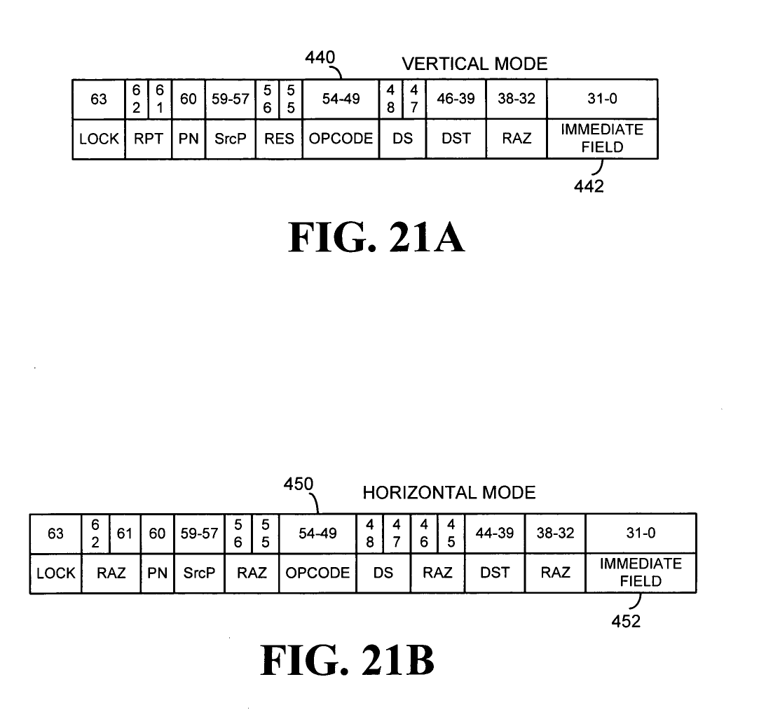

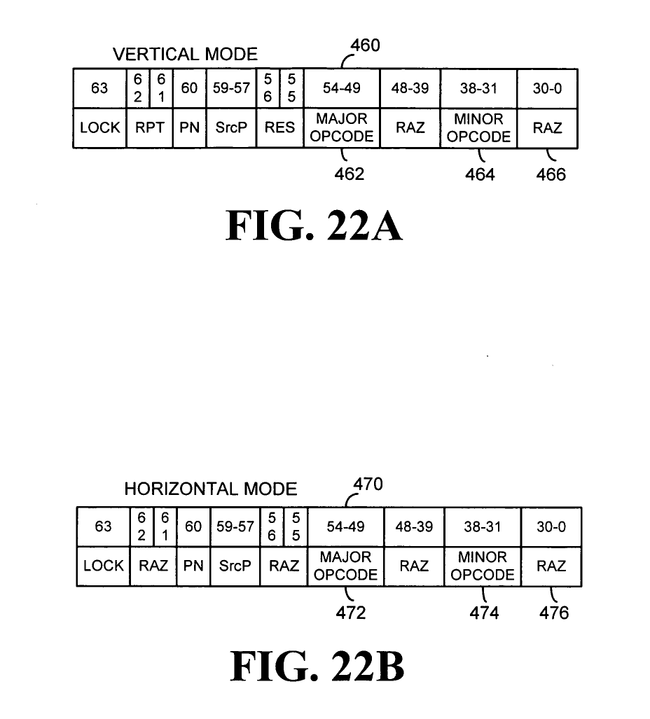

Reference is now made to FIGS. 20A and 20B, which are block diagrams illustrating exemplary instruction formats corresponding to branch instructions utilized in vertical-mode and horizontal-mode processing, respectively. The additional fields specific to the vertical-mode branch instruction format 420 and the horizontal-mode branch instruction format 430 are the label fields 422, 432 and the compare op fields 424, 434. The label field provides a jump label that is a value aligned relative to the current program counter. Although the label fields 422 and 432 are utilized in some embodiments as an immediate value, it is contemplated within the scope and spirit of this disclosure that the label field 422, 432 could also include a register identification value that points to an address or other location where a label is stored. The compare operation fields 424, 434 are used to integrate a compare operation in an instruction by performing a comparison of the result from the operation to determine whether or not to branch. In this manner the operation and the branch can be performed with a single instruction. The compare operation utilizing three bits can be encoded to support up to eight different compare functions including, but not limited to, greater than, less than, equal to, greater than or equal to, and less than, less than or equal to. In the case where instructions involve long integers, instruction formats corresponding to long immediate instructions in vertical-mode and horizontal-mode processing are illustrated in the block diagrams of FIGS. 21A and 21B, respectively. Each of the vertical-mode instruction format 440 and the horizontal-mode instruction format 450 includes a 32-bit immediate-value field 442, 452. In the case of instructions utilizing no operands, a vertical-mode instruction format and a horizontal-mode instruction format, each corresponding to zero-operand instructions, are illustrated in the block diagrams of FIGS. 22A and 22B. Both the vertical-mode instruction format 460 and the horizontal-mode instruction format 470 include major OPCODE fields 462, 472 and minor OPCODE fields 464, 474. Since this type of instruction does not feature source operands or destination registers, a significant portion of the instruction is labeled as read as zero 466, 476.

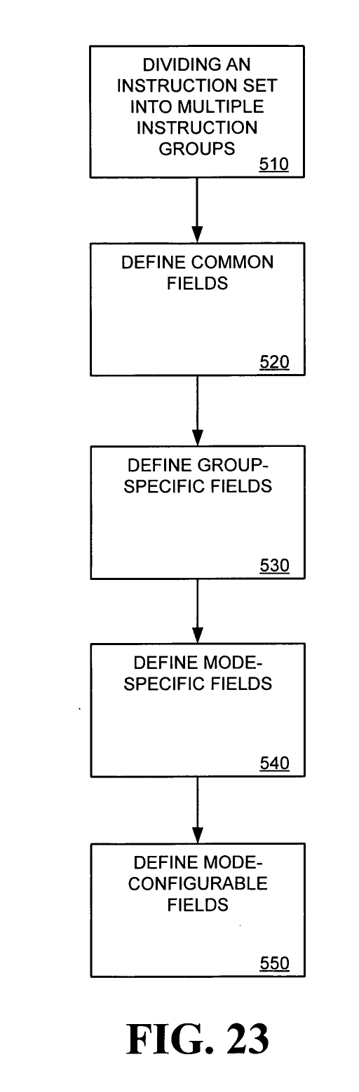

Reference is now made to FIG. 23, which is a block diagram illustrating an exemplary embodiment of a method of encoding an instruction set in a dual-mode computer processing environment. The instructions of an instruction set are divided into multiple instruction groups in block 510. The instruction groups are generally defined in terms of the number and/or type of operands. In this manner instructions having common field requirements are grouped together. Instruction requirements are analyzed to define common fields in block 520, group-specific fields in block 530, and mode-specific fields in block 540. Additionally, fields which exist within an instruction group in both the vertical-mode processing and the horizontal-mode processing, but utilize different configurations in the different processing modes, are defined as mode-configurable fields in block 550.

Embodiments of the present disclosure can be implemented in hardware, software, firmware, or a combination thereof. Some embodiments can be implemented in software or firmware that is stored in a memory and that is executed by a suitable instruction execution system. If implemented in hardware, an alternative embodiment can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The executable instructions for implementing logical, control, and mathematical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of the illustrated embodiments of the present disclosure in logic embodied in hardware or software-configured mediums.

It should be emphasized that the above-described embodiments of the present disclosure, particularly, any illustrated embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

At least the following is claimed:

1. A method for encoding an instruction set in a dual-mode computer processing environment, comprising:
dividing the instruction set into a plurality of instruction groups;
defining a plurality of common fields, adapted to store data common to the plurality of instruction groups;
defining a plurality of group-specific fields, adapted to store data specific to instructions in one or more of the plurality of instruction groups;
defining a plurality of mode-specific fields, adapted to store mode specific data; and
defining a plurality of mode-configurable fields, adapted to provide a first configuration in a first computing mode and a second configuration in a second computing mode.

2. The method of claim 1, wherein the dividing comprises classifying instructions according to operand characteristics.

3. The method of claim 2, wherein the classifying comprises an element selected from the group consisting of:
identifying instructions requiring three operands;
identifying instructions adapted to perform floating point operations on two operands; and
identifying instructions adapted to perform floating point operations on one operand.

4. The method of claim 2, wherein the classifying comprises an element selected from the group consisting of:
identifying instructions adapted to perform integer operations on at least one operand;
identifying instructions adapted to perform register immediate integer operations;
identifying instructions adapted to perform long-immediate operations;
identifying instructions adapted to perform branch operations; and
identifying instructions adapted to perform zero operand operations.

5. The method of claim 1, wherein the defining a plurality of group-specific fields comprises identifying fields common to instructions in one of the plurality of instruction groups that utilizes three operands.

6. The method of claim 1, wherein the defining a plurality of group-specific fields comprises an element selected from the group consisting of:
identifying fields exclusive to instructions in one of the plurality of instruction groups that utilizes two operands in a floating point operation; and
identifying fields exclusive to instructions in one of the plurality of instruction groups that utilizes one operand in a floating point operation.

7. The method of claim 1, wherein the defining a plurality of group-specific fields comprises identifying fields exclusive to instructions in one of the plurality of instruction groups that utilizes one or two operands in an integer operation.

8. The method of claim 1, wherein the defining a plurality of group-specific fields comprises an element selected from the group consisting of:
identifying fields exclusive to instructions in one of the plurality of instruction groups that utilizes a register-immediate operand in an integer operation;
identifying fields exclusive to instructions in one of the plurality of instruction groups that utilizes a long-immediate operand in an integer operation; and
identifying fields exclusive to instructions in one of the plurality of instruction groups that utilizes zero operands.

9. The method of claim 1, wherein the defining a plurality of group-specific fields comprises identifying fields exclusive to instructions that perform a branch operation.

10. The method of claim 1, wherein the defining a plurality of mode-configurable fields comprises an element selected from the group consisting of:
providing a first operand field;
providing a second operand field;
providing a third operand field; and
providing a destination field.

11. The method of claim 1, wherein the defining a plurality of mode specific fields comprises providing a lane replication field corresponding a portion of the plurality of instruction groups.

12. An instruction set for a dual-mode computer processing environment, comprising:
a plurality of instructions divided into a plurality of instruction groups;
a plurality of mode-specific fields in each of the plurality of instructions;
a plurality of common fields in each of the plurality of instructions; and
a plurality of group-specific fields in each of the plurality of instructions.

13. The instruction set of claim 12, further comprising a plurality of mode-configurable fields in each of the plurality of instructions.

14. The instruction set of claim 12, wherein each of the plurality of instruction groups corresponds to one of a plurality of operand configurations.

15. The instruction set of claim 14, wherein the plurality of operand configurations comprise an element selected from the group consisting of: three-source-operands in a floating point operation; two source operands in a floating-point operation; and one source operand in a floating-point operation.

16. The instruction set of claim 15, wherein the plurality of operand configurations further comprise an element selected from the group consisting of: one or two source operands in an integer operation; and register-immediate operand in an integer operation.

17. The instruction set of claim 15, wherein the plurality of operand configurations further comprise an element selected from the group consisting of: branch instructions; long-immediate instructions; and zero operand instructions.

18. The instruction set of claim 12, wherein one of the plurality of common fields comprises a lock field, configured to identify a specific instruction as locked to a specific one of a plurality of execution units.

19. The instruction set of claim 12, wherein one of the plurality of common fields comprises a predicate field, configured to specify predicate status.

20. The instruction set of claim 19, wherein the predicate field comprises predicate register information and a predicate negate field.

21. The instruction set of claim 12, wherein one of the plurality of common fields is an operation code field.

22. The instruction set of claim 21, wherein the operation code field contains complete operation code data in instructions in a first portion of the plurality of instruction groups; wherein the operation code field contains a first portion of operation code data in instructions in a second portion of the plurality of instruction groups and wherein one of the plurality of group-specific fields contains a second portion of operation code.

23. The instruction set of claim 12, wherein one of the plurality of group specific fields comprises a label field, configured to contain a jump label value.

24. The instruction set of claim 23, wherein the label field corresponds to one of the plurality of instruction groups that includes branch instructions.

25. The instruction set of claim 12, wherein one of the plurality of group specific fields comprises a minor operation code field, configured to contain supplemental operation code data.

26. The instruction set of claim 25, wherein the supplemental operation code data comprises an element selected from the group consisting of:
mathematical functions; and
logical functions.

27. The instruction set of claim 12, wherein one of the plurality of group specific fields comprises a first register file selection field corresponding to a first operand.

28. The instruction set of claim 27, wherein a portion of the plurality of group specific fields further comprises an element selected from the group consisting of:
a second register file selection field corresponding to a second operand; and
a third register file selection field corresponding to a third operand.

29. The instruction set of claim 12, wherein one of the plurality of group specific fields comprises an immediate value field configured to contain an immediate value in a register-immediate operation.

30. The instruction set of claim 12, wherein one of the plurality of mode-specific fields comprises a lane replicate field configured to replicate an operand value to additional processing lanes.

31. The instruction set of claim 12, wherein some of the plurality of mode-specific fields comprise an element selected from the group consisting of:
a first swizzle field containing a first swizzle value corresponding to a first operand;
a second swizzle field containing a second swizzle value corresponding to a second operand; and
a third swizzle field containing a third swizzle value corresponding to a third operand.

32. The instruction set of claim 31, wherein some of the plurality of mode-specific fields comprise an element selected from the group consisting of:
a write mask field; and
a lane replicate field.

33. The instruction set of claim 12, wherein the plurality of mode-specific fields are determined by a processing mode.

34. The instruction set of claim 33, wherein the processing mode comprises an element selected from the group consisting of:
vertical processing; and
horizontal processing.

35. A system for providing an instruction set in computer processing environment utilizing vertical and horizontal processing modes, comprising:
means for grouping a plurality of instructions in the instruction set into a plurality of instruction groups;
means for defining a plurality of common instruction fields common to each of the plurality of instructions;
means for defining a plurality of group-specific instruction fields specific to each of the plurality of instruction groups;
means for defining a plurality of mode-specific instruction fields configured to store a first content in the vertical processing mode and a second content in the horizontal processing mode; and
means for defining a plurality of mode-configurable instruction fields configured to provide a first data configuration in the vertical processing mode and a second data configuration in the horizontal processing mode.

36. A computing apparatus configured to utilize a dual-mode instruction set, comprising:
at least one processor configured to perform data processing in a vertical mode and horizontal mode using a plurality of instructions;
a plurality of instruction groups, each including a portion of the plurality of instructions;
a plurality of common fields in each of the plurality of instructions;
a plurality of group-specific fields configured to store content corresponding to specific instruction requirements of instructions in one of the plurality of instruction groups;
a plurality of mode-specific fields configured to store content type based on which of the vertical mode and the horizontal mode is being utilized; and
a plurality of mode-configurable fields that store a same data type in both of the vertical mode and the horizontal mode and that provide a different data format based on which of the vertical mode and the horizontal mode is being utilized.
